(19) United States
(12) Patent Application Publication
(10) Pub. No.: US 2023/0324542 A1
(43) Pub. Date: Oct. 12, 2023

(54) SYSTEMS AND METHODS FOR MILLIMETER WAVE SPATIAL AND TEMPORAL CONCEALED WEAPON COMPONENT DETECTION

(71) Applicant: Soter Technologies, LLC, Ronkonkoma, NY (US)

(72) Inventors: Derek Peterson, South Setauket, NY (US); Mohammed Elbadry, East Setauket, NY (US)

(21) Appl. No.: 18/094,543

(22) Filed: Jan. 9, 2023

Related U.S. Application Data
(63) Continuation of application No. PCT/US2021/041231, filed on Jul. 12, 2021.
Application No. PCT/US2021/041231 is a continuation-in-part of application No. 17/141,448, filed on Jan. 5, 2021.
Application No. 17/141,448 is a continuation-in-part of application No. PCT/US21/19815, filed on Feb. 26, 2021.
(60) Provisional application No. 63/050,189, filed on Jul. 10, 2020.

(51) Int. Cl. G01S 13/88; G01S 7/41; G01S 7/06

(52) U.S. Cl. CPC G01S 13/887; G01S 7/417; G01S 7/06; G01S 7/411

(57) ABSTRACT

This disclosure relates to systems and methods for spatial and temporal concealed object detection. In a particular system, there is included at least one mm-wave sensor configured to sense parameters indicative of an object, a processor, and a memory. The memory includes stored thereon instructions which, when executed by the processor, cause the system to capture a mm-wave image, by the at least one mm-wave sensor, the mm-wave image including the object, and perform spatial and temporal object detection of the object on the mm-wave image.

### CROSS REFERENCE TO RELATED APPLICATIONS

This application claims the benefit of and priority to U.S. Provisional Patent Application Ser. No. 63/050,189, filed on Jul. 10, 2020, and PCT Application PCT/US21/19815, filed on Feb. 26, 2021, which the benefit of and priority to U.S. application Ser. No. 17/141,448, filed Jan. 5, 2021, which correspond to U.S. Provisional Patent Application Ser. No. 62/989,583, filed on Mar. 13, 2020, and U.S. Provisional Patent Application Ser. No. 63/027,099, filed on May 19, 2020. The entire contents of each of the foregoing applications are hereby incorporated by reference herein.

### TECHNICAL FIELD

The present disclosure relates to systems and methods for the detection of objects through millimeter wave (mm-wave). More particularly, the present disclosure relates to systems and methods for mm-wave spatial and temporal concealed weapon component detection.

### BACKGROUND

Concealed weapons are serious security issues, especially in areas where terrorism is likely to occur and where security is paramount. Thus, by identifying concealed weapon components in areas, people can be supervised appropriately so that safety and security can be maintained. Conventional security systems include devices such as metal detectors and X-ray systems. Metal detectors can only detect metal objects such as knives and handguns. In addition, such devices cannot discriminate between innocuous items such as glasses, belt buckles, keys, and so forth, and are essentially useless in detecting modem threats posed by plastics, ceramic handguns, knives and even more dangerous items such as plastic and liquid explosives.

Further, concealed weapon component detection systems are needed to notify interested personnel or individuals to the potential of disassembled weapons that pass-through gateways to a building through spatial and temporal constraints. Thus, developments in efficiently and quickly detecting weapons and weapon components are needed.

### SUMMARY

This disclosure relates to notification systems and methods for mm-wave spatial and temporal concealed weapon component detection. In accordance with aspects of the present disclosure, a notification system includes at least one mm-wave sensor configured to sense parameters indicative of an object, a processor, and a memory. The memory having stored thereon instructions which, when executed by the processor, cause the system to capture a mm-wave image, by the at least one mm-wave sensor, the mm-wave image including the object, and perform spatial and temporal object detection of the object on the mm-wave image.

In various embodiments of the notification system, the instructions, when executed by the processor, may further cause the system to perform material recognition on the detected object by a first machine learning network. The material recognition may be based on a sensed mm-wave pulse's characteristics, including a frequency response of the sensed mm-wave pulse and/or an absorption in the material of the detected object of the mm-wave pulse.

In various embodiments of the notification system, the first machine learning network may include a long-short term memory (LSTM) network.

In various embodiments of the notification system, the instructions, when executed by the processor, may further cause the system to display the detected object on a display.

In various embodiments of the notification system, the recognized material may include metal, thermoplastic polyurethane (TPU), ABS, nylon, ABS plastic, PLA, polyamide (nylon), glass filled polyamide, stereolithography materials, epoxy resin, silver, titanium, steel, wax, photopolymers, and/or polycarbonate.

In various embodiments of the notification system, the object may include a weapon and/or a component of a weapon.

In various embodiments of the notification system, the instructions, when executed by the processor, may further cause the system to identify the detected object, which is in a predetermined list of weapon components.

In various embodiments of the notification system, the object detection may be performed by a second machine learning network.

In various embodiments of the notification system, the second machine learning network may include a convolutional neural network.

In various embodiments of the notification system, the second machine learning network may be trained based on images of weapons and components of a weapon.

In accordance with aspects of the present disclosure, a computer-implemented method for spatial and temporal concealed object detection includes capturing a mm-wave image, by at least one mm-wave sensor, the mm-wave image including an object, performing spatial and temporal object detection of the object on the mm-wave image, and displaying a message on a display, based on the detected object.

In various embodiments of the computer-implemented method, the method may further include performing material recognition on the detected object by a long-short term memory (LSTM) network. The material recognition may be based on a sensed mm-wave pulse's characteristics, including a frequency response of the mm-wave pulse and/or an absorption in the material of the detected object of the mm-wave pulse.

In various embodiments of the computer-implemented method, the method may further include displaying the detected object on a display.

In various embodiments of the computer-implemented method, the recognized material may include metal, thermoplastic polyurethane (TPU), ABS, nylon, ABS plastic, PLA, polyamide (nylon), glass filled polyamide, stereolithography materials, epoxy resin, silver, titanium, steel, wax, photopolymers, and/or polycarbonate.

In various embodiments of the computer-implemented method, the object may be a weapon and/or a component of a weapon.

In various embodiments of the computer-implemented method, the method may further include identifying the detected object, which is in a predetermined list of weapon components.

In various embodiments of the computer-implemented method, the object detection may be performed by a machine learning network.

In various embodiments of the computer-implemented method, the machine learning network may include a convolutional neural network.

In various embodiments of the computer-implemented method, the machine learning network may be trained based on images of weapons and components of a weapon.

In accordance with aspects of the present disclosure, a non-transitory computer-readable medium storing instructions which, when executed by a processor, cause the processor to perform a method. The method includes capturing a mm-wave image by at least one mm-wave sensor, the mm-wave image including an object, performing spatial and temporal object detection of the object on the mm-wave image, and displaying a message on a display, based on the detected object.

Further details and aspects of exemplary embodiments of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative embodiments, in which the principles of the technology are utilized, and the accompanying figures of which:

FIG. 1 is a block diagram of a system for the detection of objects through millimeter wave (mm-wave), in accordance with embodiments of the present disclosure,

FIG. 2 is a functional block diagram of the system of FIG. 1 in accordance with embodiments of the present disclosure,

FIG. 3 is a functional block diagram of a computing device in accordance with embodiments of the present disclosure,

FIG. 4 is a block diagram illustrating a machine learning network in accordance with embodiments of the present disclosure,

FIG. 5 is a block diagram of long-term short memory network in accordance with embodiments of the present disclosure, and

FIG. 6 is a flowchart showing a method for a location-based alert in accordance with embodiments of the present disclosure.

### DETAILED DESCRIPTION

This disclosure relates to notification systems and methods for mm-wave spatial and temporal concealed weapon component detection.

Although the present disclosure will be described in terms of specific embodiments, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary embodiments illustrated in the figures, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

The disclosed detection systems and methods detect concealed weapons, weapon components, and/or objects that may cause harm (for example, but not limited to, sharp knives, firearms, etc.). The disclosed systems and methods include an artificial intelligence component which leverages various machine learning networks (e.g., convolutional neural networks and/or long-term short memory networks) to detect spatially and temporally components of a weapon that may or may not come together for assembly. The machine learning networks detect weapon-forming components that enter premises within a duration and will flag all personnel who are carrying components accordingly. The materials of the components can vary, for example from metal to 3D printed materials.

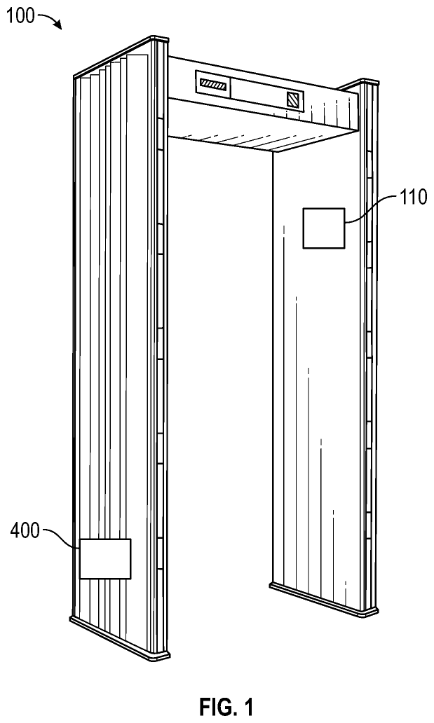

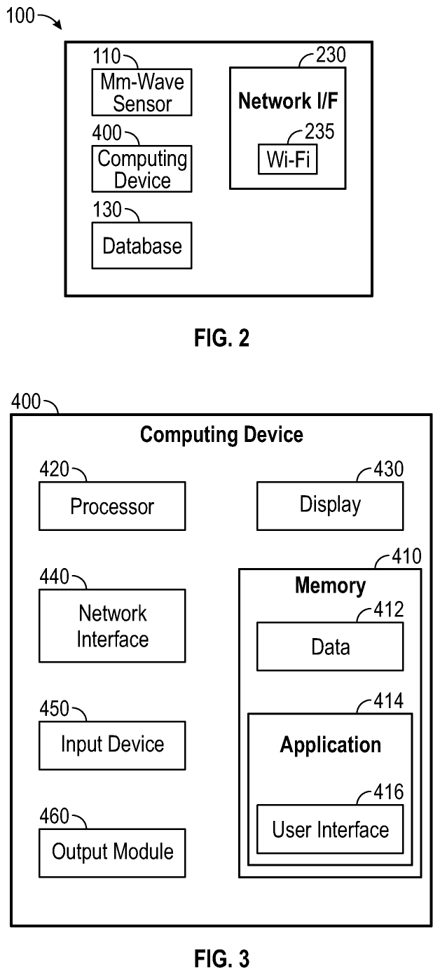

FIGS. 1 and 2 illustrate a detection system 100 for mm-wave spatial and temporal concealed weapon component detection according to embodiments of the present disclosure. The detection system 100 includes a mm-wave sensor 110, a computing device 400 for processing mm-wave sensor signals, a network interface 230, and a database 130.

The mm-wave sensor 110 is configured to detect parameters indicative of an object. Millimeter wave sensors provide a means of an examination of structures through controlled electromagnetic interactions. Both metallic and nonmetallic structures reflect and scatter electromagnetic waves striking the outer surfaces. Nonmetallic, i.e., dielectric, materials allow for electromagnetic waves to penetrate the surface and scatter or reflect off of subsurface objects and features. By measuring surface and subsurface reflectivity and scattering by the controlled launching and receiving of electromagnetic waves provides information that can indicate surface and subsurface feature geometry, material properties, and overall structural condition. Millimeter waves can be effective for weapon detection on personnel because the waves readily pass through most clothing materials and reflect from the body and any concealed items (e.g., weapon components). These reflected waves can be focused by an imaging system that will reveal the size, shape, and orientation of the concealed object.

Mm-wave sensor systems can be used to form high-resolution images that can reveal discrepancies from the expected image of a person and reveal the shape and position of the concealed items, which enables the development of high-performance and versatile concealed weapon detection imaging systems. It is contemplated that both active and passive mm-wave imaging systems may be used in the disclosed systems and methods. Active imaging systems primarily image the reflectivity of the person/scene, including the effect of the object's shape and orientation. Passive systems measure the thermal (e.g., black-body) emission from the scene, which will include thermal emission from the environment that is reflected by objects in the scene (including the person).

The human body can be considered a good conductor and strongly reflects and absorbs waves in the millimeter-wave range. Concealed objects can generally be classified as dielectrics with unknown shape and dielectric properties. Metals can be considered to be a limiting case of a highly conductive dielectric. Dielectric objects, including metals, the human body, and concealed items, will all produce reflections based on the Fresnel reflection at each air—dielectric or dielectric—dielectric interface. Additionally, these reflections will be altered by the shape, texture, and orientation of the surfaces. One of skill in the art is familiar with how to implement a mm-wave sensor to capture a mm-wave image.

The database 130 may include historical data, which is time-series and location-specific data for objects, weapons, and/or weapon components for each location where the mm-wave sensor 110 has been installed. In an aspect, the computing device 400 may analyze the historical data to predict occurrences of object detection at the location so that appropriate actions may be proactively and expeditiously be taken at the location.

In an aspect, when the mm-wave sensor 110 transmits detected results to the computing device 400, the computing device 400 may acquire from the database 130 the profile for the location where the mm-wave sensor 110 is installed and the time when the detected results are obtained and analyzes the detected results to identify objects based on the base data.

Turning now to FIG. 3, a simplified block diagram is provided for a computing device 400, which can be implemented as a control server, the database 130, a message server, and/or a client-server. The computing device 400 may include a memory 410, a processor 420, a display 430, a network interface 440, an input device 450, and/or an output module 460. The memory 410 includes any non-transitory computer-readable storage media for storing data and/or software that is executable by the processor 420 and which controls the operation of the computing device 400.

In an aspect, the memory 410 may include one or more solid-state storage devices such as flash memory chips. Alternatively, or in addition to the one or more solid-state storage devices, the memory 410 may include one or more computer-readable storage media/devices connected to the processor 420 through a mass storage controller (not shown) and a communications bus (not shown). Although the description of computer-readable media contained herein refers to solid-state storage, it should be appreciated by those skilled in the art that computer-readable storage media can be any media that can be accessed by the processor 420. That is, computer-readable storage media may include non-transitory, volatile and/or non-volatile, removable and/or non-removable media implemented in any method or technology for storage of information such as computer-readable instructions, data structures, program modules, and/or other data. For example, computer-readable storage media includes RAM, ROM, EPROM, EEPROM, flash memory or other solid-state memory technology, CD-ROM, DVD, Blu-Ray or other optical storage, magnetic cassettes, magnetic tape, magnetic disk storage or other magnetic storage devices, or any other medium which can be used to store the desired information and which can be accessed by the computing device 400.

The memory 410 may store application 414 and/or data 412 (e.g., mm-wave sensor data). The application 414 may, when executed by processor 420, cause the display 430 to present the user interface 416. The processor 420 may be a general-purpose processor, a specialized graphics processing unit (GPU) configured to perform specific graphics processing tasks while freeing up the general-purpose processor to perform other tasks, and/or any number or combination of such processors. The display 430 may be touch-sensitive and/or voice-activated, enabling the display 430 to serve as both an input and output device. Alternatively, a keyboard (not shown), mouse (not shown), or other data input devices may be employed. The network interface 440 may be configured to connect to a network such as a local area network (LAN) consisting of a wired network and/or a wireless network, a wide area network (WAN), a wireless mobile network, a Bluetooth® network, and/or the internet.

For example, the computing device 400 may receive, through the network interface 440, detection results for the mm-wave sensor 110 of FIG. 1, for example, a detected object from the mm-wave sensor 110. The computing device 400 may receive updates to its software, for example, the application 414, via the network interface 440. It is contemplated that updates may include “over-the-air” updates. The computing device 400 may also display notifications on the display 430 that a software update is available.

The input device 450 may be any device by which a user may interact with the computing device 400, such as, for example, a mouse, keyboard, foot pedal, touch screen, and/or voice interface. The output module 460 may include any connectivity port or bus, such as, for example, parallel ports, serial ports, universal serial buses (USB), or any other similar connectivity port known to those skilled in the art. The application 414 may be one or more software programs stored in the memory 410 and executed by the processor 420 of the computing device 400. The application 414 may be installed directly on the computing device 400 or via the network interface 440. The application 414 may run natively on the computing device 400, as a web-based application, or any other format known to those skilled in the art.

In an aspect, the application 414 will be a single software program having all of the features and functionality described in the present disclosure. In other aspects, the application 414 may be two or more distinct software programs providing various parts of these features and functionality. Various software programs forming part of the application 414 may be enabled to communicate with each other and/or import and export various settings and parameters relating to the detection of objects, weapons, and/or components of weapons.

The application 414 communicates with a user interface 416, which generates a user interface for presenting visual interactive features on the display 430. For example, the user interface 416 may generate a graphical user interface (GUI) and output the GUI to the display 430 to present graphical illustrations.

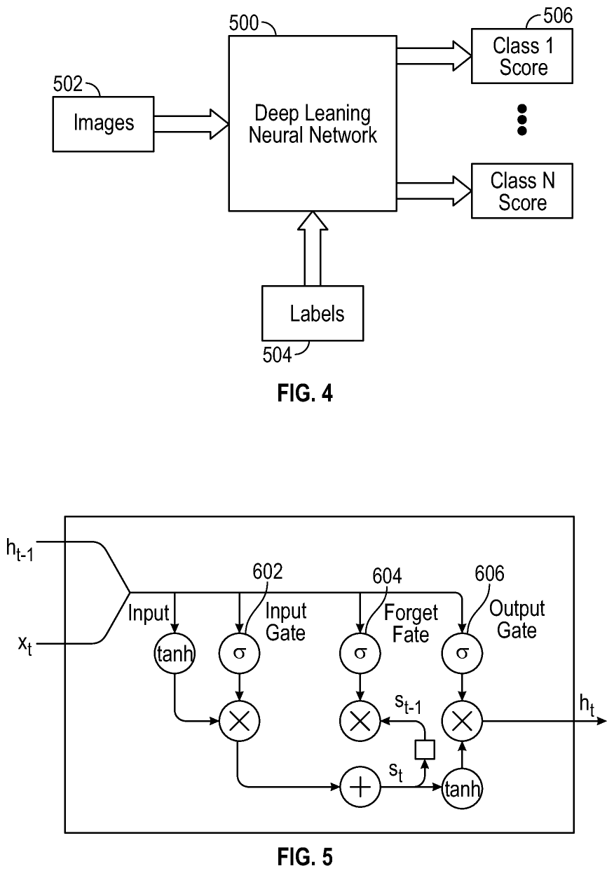

With reference to FIG. 4, a block diagram for a deep learning neural network 500 for classifying images is shown in accordance with some aspects of the disclosure. In some systems, a deep learning neural network 500 may include a convolutional neural network (CNN) and/or a recurrent neural network. Generally, a deep learning neural network includes multiple hidden layers. As explained in more detail below, the deep learning neural network 500 may leverage one or more CNNs to classify one or more images, taken by the mm-wave sensor 110 (see FIG. 2). The deep learning neural network 500 may be executed on the computer system 400 (FIG. 3). Persons skilled in the art will understand the deep learning neural network 500 and how to implement it.

In machine learning, a CNN is a class of artificial neural network (ANN), most commonly applied to analyzing visual imagery. The convolutional aspect of a CNN relates to applying matrix processing operations to localized portions of an image, and the results of those operations (which can involve dozens of different parallel and serial calculations) are sets of many features that are delivered to the next layer. A CNN typically includes convolution layers, activation function layers, and pooling (typically max pooling) layers to reduce dimensionality without losing too many features. Additional information may be included in the operations that generate these features. Providing unique information that yields features that give the neural networks information can be used to ultimately provide an aggregate way to differentiate between different data input to the neural networks.

Generally, a deep learning neural network 500 (e.g., a convolutional deep learning neural network) includes an input layer, a plurality of hidden layers, and an output layer. The input layer, the plurality of hidden layers, and the output layer are all comprised of neurons (e.g., nodes). The neurons between the various layers are interconnected via weights. Each neuron in the deep learning neural network 500 computes an output value by applying a specific function to the input values coming from the previous layer. The function that is applied to the input values is determined by a vector of weights and a bias. Learning, in the deep learning neural network, progresses by making iterative adjustments to these biases and weights. The vector of weights and the bias are called filters (e.g., kernels) and represent particular features of the input (e.g., a particular shape). The deep learning neural network 500 may output logits 506.

The deep learning neural network 500 may be trained based on labeling 504 training images 502 and/or objects in training images 502. For example, an image 502 may be a component of a weapon (for example, the barrel of a gun). The training images may include schematics and/or assembly diagrams (e.g., manufacturing drawings) of weapons. In some methods in accordance with this disclosure, the training may include supervised learning. The training further may include augmenting the training images 502 to include adding noise, changing colors, hiding portions of the training images, scaling of the training images 502, rotating the training images, and/or stretching the training images. Persons skilled in the art will understand training the deep learning neural network 500 and how to implement it.

In some methods in accordance with this disclosure, the deep learning neural network 500 may be used to classify images captured by the mm-wave sensor 110 (see FIG. 2). The classification of the images may include each image being classified as a component of a weapon. For example, the image classifications may include a barrel, a handle, ammunition, etc. Each of the images may include a classification score. A classification score includes the outputs (e.g., logits) after applying a function such as a SoftMax to make the outputs represent probabilities.

FIG. 5 is a block diagram of an exemplary long-term short memory (LSTM) network in accordance with aspects of the present disclosure. An LSTM network is a recurrent neural network (RNN) that has LSTM cell blocks. A common LSTM unit is composed of a cell, an input gate 602, an output gate 606, and a forget gate 604. The cell remembers values over arbitrary time intervals, and the three gates regulate the flow of information into and out of the cell. Generally, the cell is responsible for keeping track of the dependencies between the elements in the input sequence. The input gate 602 controls the extent to which a new value flows into the cell, the forget gate 604 controls the extent to which a value remains in the cell, and the output gate 606 controls the extent to which the value in the cell is used to compute the output activation of the LSTM unit. The activation function of the LSTM gates may include a logistic sigmoid function. There are connections into and out of the LSTM gates, a few may be recurrent. The weights of these connections, which need to be learned during training, determine how the gates operate. h_{t-I} is the previous cell's output. Xₜ is the input vector. hₜ is the current cell output.

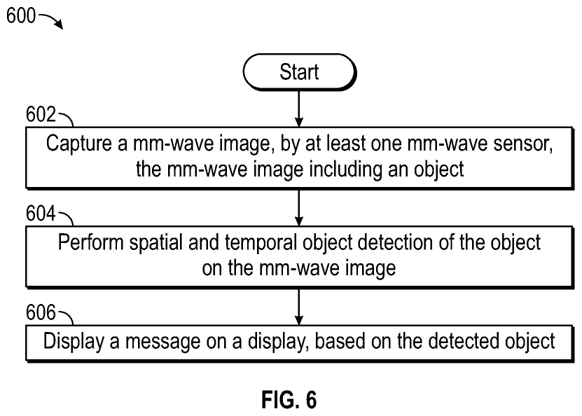

With reference to FIG. 6, a method is shown for spatial and temporal concealed object detection. Persons skilled in the art will appreciate that one or more operations of the method 600 may be performed in a different order, repeated, and/or omitted without departing from the scope of the disclosure. In various aspects, the illustrated method 500 can operate in controller 400 (FIG. 3), in a remote device, or in another server or system. Other variations are contemplated to be within the scope of the disclosure. The operations of method 600 will be described with respect to a controller, e.g., controller 400 (FIG. 3) of system 100 (FIG. 1), but it will be understood that the illustrated operations are applicable to other systems and components thereof as well.

The disclosed method may be executed when a person passes through/by the system of FIG. 1.

Initially, at step 602, the method captures a mm-wave image by at least one mm-wave sensor of the system of FIG. 1. The mm-wave image includes an object (e.g., a weapon and/or a component of a weapon). In various aspects, the mm-wave sensor may be an active sensor or a passive sensor.

At step 604, the method performs spatial and temporal object detection of the object on the mm-wave image.

In various embodiments, the system may identify the detected object, which is in a predetermined list of weapon components. The object detection may be performed by a machine learning network (e.g., a convolutional neural network). For example, the machine learning network may be a CNN with six layers. The machine learning network may be trained based on images of weapons, components of a weapon, and/or schematics of how a weapon is out together. In various aspects, the object detection may be performed locally and/or on a remote computing device.

In various aspects, the detected object may be displayed on a display. The display may be a component of the system, or may be remote (e.g., on a remote station, or on a mobile device).

In various aspects, the method may perform material recognition on the detected object by a machine learning network (e.g., a neural network and/or an LSTM). The material recognition may be based on a sensed mm-wave pulse's characteristics, including at least one of a frequency response of the sensed mm-wave pulse and absorption in the material of the detected object of the mm-wave pulse. For example, 3D printed materials generally may have a different absorption than metal or cloth. In various aspects, the material recognition may be performed locally and/or on a remote computing device. The machine learning network may be trained on different materials. The recognized material may include metal, thermoplastic polyurethane (TPU), ABS, nylon, ABS plastic, PLA, polyamide (nylon), glass filled polyamide, stereolithography materials, epoxy resin, silver, titanium, steel, wax, photopolymers, and/or polycarbonate.

In various aspects, the recognized material may be displayed on a display. The display may be a component of the system, or may be remote (e.g., on a remote station, or on a mobile device).

At step 606, the method displays a message on a display, based on the detected object. In various aspects, the method may receive data from multiple sensors at different locations, for example, a building with multiple entrances with a mm-wave sensor 110 (FIG. 1) located at each entrance. The method may aggregate the data from multiple sensors. For example, someone may try and sneak components of a weapon into multiple entrances of the building to build a completed weapon once passing security with the individual parts. The method would detect the several components at the various entryways and send an alert notification or display a warning. The method may detect weapon-forming components that enter premises within a duration, from one or more entrances, and will flag all personnel who are carrying components accordingly.

In various aspects, the method may an alert notification to a user device estimated to be nearest to the detection sensor. The alert may be, for example, an email, a text message, or a multimedia message, among other things. The message may be sent by the mm-wave sensor 110 or sent by one or more servers, such as a client server or a message server. In various embodiments, the alert notification includes at least one of a location of the mm-wave sensor 110, a time of the detection of the sensed occurrence, an image of the object, and/or an image of the person carrying the object.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference, numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A), (B), (C), (A and B), (A and C), (B and C), or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages that are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for spatial and temporal concealed object detection, comprising:
at least one mm-wave sensor configured to sense parameters indicative of an object,
a processor, and
a memory having stored thereon instructions which, when executed by the processor, cause the system to:
capture a mm-wave image, by the at least one mm-wave sensor, the mm-wave image including the object; and
perform spatial and temporal object detection of the object on the mm-wave image.

2. The system of claim 1, wherein, the instructions, when executed by the processor, further cause the system to:
perform material recognition on the detected object by a first machine learning network,
wherein the material recognition is based on a sensed mm-wave pulse's characteristics, including at least one of a frequency response of the sensed mm-wave pulse or an absorption in the material of the detected object of the mm-wave pulse.

3. The system of claim 2, wherein the first machine learning network includes a long-short term memory (LSTM) network.

4. The system of claim 2, wherein the instructions, when executed by the processor, further cause the system to display the detected object on a display.

5. The system of claim 2, wherein the recognized material includes at least one of metal, thermoplastic polyurethane (TPU), ABS, nylon, ABS plastic, PLA, polyamide (nylon), glass filled polyamide, stereolithography materials, epoxy resin, silver, titanium, steel, wax, photopolymers, or polycarbonate.

6. The system of claim 1, wherein the object is at least one of a weapon or a component of a weapon.

7. The system of claim 6, wherein the instructions, when executed by the processor, further cause the system to identify the detected object which is in a predetermined list of weapon components.

8. The system of claim 1, wherein the object detection is performed by a second machine learning network.

9. The system of claim 8, wherein the second machine learning network includes a convolutional neural network.

10. The system of claim 8, wherein the second machine learning network is trained based on images of weapons and components of a weapon.

11. A computer-implemented method for spatial and temporal concealed object detection, comprising:
capturing a mm-wave image, by at least one mm-wave sensor, the mm-wave image including an object; and
performing spatial and temporal object detection of the object on the mm-wave image.

12. The computer-implemented method of claim 11, further comprising:
performing material recognition on the detected object by a long-short term memory (LSTM) network,
wherein the material recognition is based on a sensed mm-wave pulse's characteristics, including at least one of a frequency response of the mm-wave pulse or an absorption in the material of the detected object of the mm-wave pulse.

13. The computer-implemented method of claim 12, further comprising displaying the detected object on a display.

14. The computer-implemented method of claim 12, wherein the recognized material includes at least one of metal, thermoplastic polyurethane (TPU), ABS, nylon, ABS plastic, PLA, polyamide (nylon), glass filled polyamide, stereolithography materials, epoxy resin, silver, titanium, steel, wax, photopolymers, or polycarbonate.

15. The computer-implemented method of claim 11, wherein the object is at least one of a weapon or a component of a weapon.

16. The computer-implemented method of claim 15, further comprising identifying the detected object which is in a predetermined list of weapon components.

17. The computer-implemented method of claim 11, wherein the object detection is performed by a machine learning network.

18. The computer-implemented method of claim 17, wherein the machine learning network includes a convolutional neural network.

19. The computer-implemented method of claim 17, wherein the machine learning network is trained based on images of weapons and components of a weapon.

20. A non-transitory computer-readable medium storing instructions which, when executed by a processor, cause the processor to perform a method for spatial and temporal concealed object detection, the method comprising:
capturing a mm-wave image, by at least one mm-wave sensor, the mm-wave image including an object; and
performing spatial and temporal object detection of the object on the mm-wave image.
